(19) United States
(12) Patent Application Publication
(10) Pub. No.: US 2026/0035051 A1
(43) Pub. Date: Feb. 5, 2026

(54) HUB ASSEMBLY FOR A BICYCLE WHEEL

(71) Applicant: CLASSIFIED CYCLING BV, Antwerpen (BE)

(72) Inventor: Roëll Marie VAN DRUTEN, Eindhoven (NL)

(21) Appl. No.: 18/998,079

(22) PCT Filed: Jul. 25, 2023
(86) PCT No.: PCT/EP2023/070634

§ 371 Date: Jan. 23, 2025

(30) Foreign Application Priority Data
Jul. 25, 2022 (NL) 2032587

(51) Int. Cl. B62M 6/65; B62M 9/122; B62M 11/14

(52) U.S. Cl. CPC B62M 6/65; B62M 9/122; B62M 11/14

(57) ABSTRACT

The disclosure relates to a hub assembly for a bicycle wheel. The hub assembly comprises a driver, rotatable about a first axis, for being mounted to a sprocket; a hub shell, rotatable about a second axis parallel to the first axis, for being mounted to the bicycle wheel; a transmission selectively operable according to a plurality of different transmission ratios, and operatively connected between the driver and the hub shell, and an electric propulsion motor connected to the hub shell via the transmission.

### FIELD

The invention relates to a hub assembly for a bicycle.

### BACKGROUND

Various bicycle transmission systems for bicycles are known. In performance oriented bicycles, the transmission system traditionally includes a front derailleur and a rear derailleur for shifting gears of the transmission system. An alternative to derailleurs is formed by gear hubs, where shifting of gears is accommodated by a gear shifting mechanism inside the, generally rear, wheel hub. A hybrid form is known where a gear hub torque transmission having at least two selectable gear ratios is coupled between the rear wheel hub and the rear sprocket. Herein the rear sprocket can be part of a cassette of sprockets, each sprocket being selectable through a rear derailleur. The gear hub can in such example replace of a front derailleur. A gear hub can include a planetary gear set, wherein a clutch can be used for selectively coupling two rotational members of the planetary gear set, e.g. a planet carrier and a ring gear.

Many conventional bicycle transmission systems have in common that up- and downshifting is not always possible, depending on the riders pedal force. In some systems, it is required that the rider stops pedaling, or at least stops providing torque load to the system to allow up-shifting and/or down-shifting. Also, many conventional gear hubs are relatively heavy and inefficient.

### SUMMARY

It is an object to propose an improved hub assembly and wheel for a bicycle. In a more general sense it is an object to overcome or ameliorate at least one of the disadvantages of the prior art, or at least provide alternative processes and structures that are more effective than the prior art. At any rate it is at the very least aimed to offering a useful choice and contribution to the existing art.

According to an aspect is provided a hub assembly for a bicycle wheel. The hub assembly comprises a driver, rotatable about a first axis, for being mounted to a sprocket. The hub assembly comprises a hub shell, rotatable about a second axis parallel to the first axis, for being mounted to the bicycle wheel. The hub shell can e.g. comprise spokes flanges for mounting the hub shell to a wheel rim via a plurality of spokes. The hub assembly comprises a transmission selectively operable according to a plurality of different transmission ratios, and operatively connected between the driver and the hub shell. Thus, the driver can drive the transmission, and the transmission can, as a result, drive the hub shell. The hub assembly comprises an electric propulsion motor connected to the hub shell via the transmission. Thus, the electric propulsion motor can drive the transmission, and the transmission can, as a result, drive the hub shell. The transmission can comprise a transmission input and a transmission output, wherein the driver is connected to the transmission input for driving the transmission, wherein the electric propulsion motor is connected to the transmission input for driving the transmission, and wherein the transmission output is connected to the hub shell for driving the hub shell according to one of the plurality of transmission ratios. The electric propulsion motor being part of the hub assembly provides the advantage to be able top provide a self-contained unit for propulsion of a bicycle based e.g. on muscle power via the driver and/or electric power via the electric propulsion motor. Having the electric propulsion motor drive the transmission, e.g. by being connected to the transmission input, allows the different transmission ratios to be applied also to driving torque and/or speed supplied by the electric propulsion motor.

Optionally, the hub assembly comprising a, e.g. sealed, hub chamber formed by the hub shell, the hub chamber housing the transmission and optionally the electric propulsion motor. Optionally, the hub shell comprises an inner part housing the transmission and optionally the electric propulsion motor, and an outer part for being mounted to the bicycle wheel, wherein the outer part is removably mounted to the inner part. Hence, the inner part with the transmission and electric propulsion motor can be provided as a subassembly that can easily be mounted into the outer part. This can e.g. allow easy exchange of the outer part with a different outer part for applying the transmission and electric propulsion motor to a different wheel. This can e.g. allow easy exchange of the inner part with a different inner part for providing a wheel with a different transmission and electric propulsion motor.

Optionally, the hub assembly comprises a reduction gear between the electric propulsion motor and the transmission input.

Optionally, the hub assembly comprises a freewheel between the driver and the transmission input. Optionally, The hub assembly comprises a freewheel between the electric propulsion motor and the transmission input.

Optionally, the electric propulsion motor has a stator that is rotationally coupled to a wheel axle of the hub assembly, and a rotor that is rotatably arranged relative to the stator. Optionally, wherein the electric propulsion motor is concentric about the second axis.

Optionally, the hub assembly comprises a thru-axle extending through a hollow wheel axle of the hub assembly. The hollow wheel axle can be the aforementioned wheel axle.

Optionally, the transmission comprises a planetary transmission selectively operable according to a plurality of different transmission ratios.

Optionally, the hub assembly comprises an intermediate drive part having an input connected to the driver and an output connected to the planetary transmission, wherein the intermediate drive part extends between the intermediate drive part output internal to the hub chamber and the intermediate drive part input external to the hub chamber.

Optionally, the planetary transmission includes a first planetary gear set selectively operable according to a first transmission ratio and a second transmission ratio and having a first clutch for switching from the first transmission ratio to the second transmission ratio and/or vice versa.

Optionally, the sprocket is part of a cassette or set of sprockets including at most ten different sprockets, particularly at most eight different sprockets, more particular at most six different sprockets, more particular at most four different sprockets.

Optionally, the hub assembly comprises an antenna for wirelessly communicating with an external component, such as a controller and/or a shifter, wherein the antenna is optionally arranged within the sealed hub chamber.

Optionally, the hub assembly comprises a controller for controlling the transmission, wherein the controller optionally further is arranged for further controlling a derailleur.

Optionally, the hub assembly comprises an axle, such as the aforementioned wheel axle, extending longitudinally along the second axis between a drive side end near the driver and a non-drive side end opposite the drive side; and a torque support for supporting torque from the axle onto a frame of the bicycle, wherein the torque support is optionally arranged at the drive side.

According to an aspect is provided a wheel for a bicycle, comprising a hub assembly as described hereinabove.

According to an aspect is provided a bicycle, comprising a wheel and/or a hub assembly as described hereinabove.

According to an aspect is provided a drive train for a bicycle, comprising a hub assembly as described hereinabove, and further comprising a crank assembly comprising a crank, a chain ring and a crank transmission arranged between the crank and the chain ring, selectively operable according to a plurality of different transmission ratios.

According to an aspect, a hub assembly for a bicycle wheel is provided. The hub assembly comprises a driver, rotatable about a first axis, for being mounted to a sprocket; a hub shell, rotatable about a second axis parallel to the first axis, for being mounted to the bicycle wheel; and a transmission selectively operable according to a plurality of different transmission ratios, and operatively connected between the driver and the hub shell. The second axis may correspond to the wheel axis of the bicycle wheel. The first and second axis may coincide. Optionally, the driver is movable relative to the hub shell in a direction transverse to the second axis, between first and second extreme positions. The first extreme position may be a concentric position in which the first axis coincides with the second axis. and the second extreme position may be an eccentric position in which the first axis is offset from the second axis. Hence, the driver can be used to tension a chain, and/or provide for chain slack to facilitate removal of the wheel from the bicycle frame.

Optionally, the transmission comprises a continuously variable transmission (CVT) selectively operable according to a plurality of transmission ratios within a continuous range of transmission ratios. The CVT can be a ratcheting type of CVT, e.g. using freewheel or one-way drive modules. The CVT can be used for increasing the number of transmission ratios obtainable with the transmission. The CVT may be similar to the CVT as disclosed in co-pending patent application PCT/EP2022/060920, which is incorporated by reference in its entirety.

Optionally, the CVT is controlled to selectively operate according to a transmission ratio within a finite set of predetermined transmission ratios. Said finite set of predetermined transmission ratios is a subset of the theoretical infinite set of transmission ratios defined by the continuous range of transmission ratios obtainable by the CVT. The CVT can be controlled to switch between transmission ratios of the predetermined finite set of transmission ratios, e.g. between a predetermined first CVT transmission ratio and a predetermined second CVT transmission ratio, etc. The finite set of transmission ratios may for instance include at most eleven different transmission ratios, such as at most five different transmission ratios. Hence, the CVT may be used as a discrete transmission, i.e. having discrete transmission ratios.

Optionally, the finite set of transmission ratios is (pre) programmable by a user. Hence, the discrete transmission ratio steps of the CVT may be (pre) programmably adaptable.

Optionally, the continuously variable transmission includes a first drive element connected to the driver and rotatable about the first axis; a second drive element connected to the hub shell and rotatable about the second axis, the first drive element being movable relative to the second drive element in a direction transverse to the first and second axis; coupling elements provided at a constant first radius from the first axis and at a variable second radius from the second axis for transferring torque between the first drive element and the second drive element. Alternatively, the coupling elements can be provided at a constant first radius from the second axis and at a variable second radius from the first axis for transferring torque between the first drive element and the second drive element. The coupling elements are provided for transferring torque between the first drive element and the second drive element. The first drive element and the second drive element are movable relative to each other in a direction transverse to the first and second axis for transferring torque at different transmission ratios. By varying the relative displacement between the first drive element being associated with the first axis, and the second drive element being associated with the second axis, the variable second radius at which torque is transferred between the first and second drive elements is varied. Hence, various transmission ratios can be obtained between the first and second drive elements. Hence, various transmission ratios can be obtained between an input and an output of the CVT. The CVT can be made into a relative small form factor, with a relatively few components and small mass.

Optionally, the first drive element is fixed to or integrated with the driver. Hence, the driver can be moved relative to the hub shell in a direction transverse to the second axis, between a concentric position in which the first axis coincides with the second axis and an eccentric position in which the first axis is offset from the second axis.

Optionally, the second drive element is coupled or couplable to the hub shell.

Optionally, the hub assembly comprises a freewheel between the second drive element and the hub shell. Although the CVT may include one or more freewheels for preventing the second drive element from rotationally driving the first drive element, the hub assembly may nonetheless include an additional freewheel for increased coasting efficiency, e.g. for performance oriented bicycles. The hub shell can thus be prevented to drive the driver.

Optionally, the coupling elements are coupled to the second drive element in a tangential direction, and movable relative to the second drive element in a radial direction. Thus, the coupling elements can move radially relative to the second axis, while remaining tangentially coupled to the second drive element. Optionally, the coupling elements are coupled to the first drive element in a radial direction at the first radius from the first axis, and movable relative to the first drive element in a first tangential direction. Optionally, the coupling elements are couplable to the first drive element in a second tangential direction opposite the first tangential direction. Thus, the coupling elements can be maintained at a predetermined radial distance relative to the first axis. The coupling elements can e.g. be freely movable in the first tangential direction relative to the first drive member and couple to the first drive element in the second tangential direction relative to the first drive member. Hence, the first drive element can drive the coupling elements in rotation in the first tangential direction, and the first drive element can freely move in the second tangential direction relative to the coupling elements. Also, the coupling elements can drive the first drive element in rotation in the second tangential direction, and the coupling elements can freely move in the first tangential direction relative to the first drive element.

Optionally, the first drive element is pivotally movable about a pivot axis that extends parallel to the first axis, for being pivotally moved relative to the second drive element in a direction transverse to the first axis.

Optionally, the first drive element comprises a first concentric guide extending concentrically around the first axis, wherein the first concentric guide is arranged for guiding a movement of the coupling elements in the first tangential direction. The first concentric guide may for example be a slot provided in the first drive element, which slot concentrically extends around the first axis.

Optionally, the first concentric guide and the coupling elements form or include a one-way coupling for allowing movement of the coupling elements relative to the first concentric guide in the first tangential direction, and for blocking movement of the coupling elements relative to the first concentric guide in the second tangential direction. Each of the coupling elements may for example comprise a one-way unit which is arranged to be wedged between an inner race and an outer race of the first concentric guide when driven in the second tangential direction.

Optionally, each of the coupling elements comprises a wedging body which is tiltable about a tilt axis between a neutral position in which free movement of the coupling element relative to the first concentric guide is allowed, and a wedged position in which the wedging body is wedgingly engaged with the first concentric guide. For example the wedging body may be wedged between two races of the first concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the coupling elements comprises at least one roller for activating the tilting of the wedging body from the neutral position to the wedged position.

Optionally, a first end of the wedging body is provided with a converging wedging recess for cooperating with a first roller and a second end of the wedging body, opposite the first end, is provided with a diverging wedging recess for cooperating with a second roller. Here converging and diverging are defined as seen in a direction away from the centre of the wedging body. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the first concentric guide and a converging wedging face of the converging wedging recess. The second roller may for example be provided between an outer race of the first concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises first radial guides extending at least radially with respect to the second axis, i.e. having a radial component. The first radial guides are arranged for guiding movement of the coupling elements in radial direction and for transmitting torque in tangential direction. The first radial guides may comprise radially extending slots in a body of the second drive element.

Optionally, each of the coupling elements comprises a guide wheel for running along the first radial guides.

Optionally, the coupling elements are movably, such as hingedly, connected to the second drive element for allowing a radial movement of the coupling elements relative to the second drive element.

Optionally, each wedging body is tiltable about a tilt axis between a neutral position in which free movement of the coupling element relative to the first concentric guide is allowed, and a wedged position in which each wedging body is wedgingly engaged with the first concentric guide.

Optionally, each of the coupling elements comprises two wedging bodies. Optionally, each wedging body of the first coupling element is tiltable about a common tilt axis between a neutral position in which free movement of the coupling element relative to the first concentric guide is allowed, and a wedged position in which each wedging body is wedgingly engaged with the first concentric guide.

Optionally, the guide wheel is rotatable about the common tilt axis, wherein the two wedging bodies are arranged on either side of the guide wheel.

Optionally, the transmission is arranged for pivoting the first drive element about the pivot axis between a first extreme position and a second extreme position, e.g. between a concentric position in which the first axis coincides with the second axis and an eccentric position in which the first axis is offset from the second axis.

Optionally, the first drive element is pivotable about the pivot axis to a selective position within a continuous pivot range defined between the first extreme position and the second extreme position, e.g. between the concentric position and the eccentric position, wherein the continuous pivot range is symmetrical with respect to a horizontal plane through the pivot axis.

Optionally, the first drive element forms a center cavity for allowing an axle to extend therethrough, wherein the pivot axis is arranged in an intersection space, which intersection space is defined as the intersection of the center when the first drive element is in the first extreme position, e.g. the concentric position, and the center cavity when the first drive element is in the second extreme position, e.g. the eccentric position. Hence, the center cavity portion is displaced along with the first drive element between the either end of the pivot range, i.e. the first and second extreme position. The overlapping area between the center cavity at either end of the pivot range defines the intersection space. It will be appreciated that, since the first drive element is movable transverse to the first and second axis, the intersection space may extend longitudinally in a direction parallel to the first and second axes. Hence, the intersection space may be substantially cylindrically shaped, i.e. having a constant cross-section in a plane transverse to the first and second axis.

Optionally, the hub assembly comprises an actuator, e.g. an electrically powered actuator, for actuating a movement of the first drive element relative to the second drive element in a direction transverse to the second axis, wherein the actuator is arranged in the intersection space.

Optionally, with respect to an intended drive direction of the bicycle, the pivot axis is arranged at a trailing side of the second axis. It will be appreciated that the intended drive direction corresponds to a forward direction in which the bicycle is intended to be ridden by a user. The first and second axis may extend transverse to the intended drive direction of the bicycle. Alternatively, the pivot axis may be arranged at a leading side of the second axis.

Optionally, the hub assembly comprises a sealed hub chamber formed by the hub shell. The sealed hub chamber may e.g. be sealed against debris, preferably against dust, more preferably against liquid, such as water.

Optionally, the continuously variable transmission is external to the sealed hub chamber. In an alternative configuration, the continuously variable transmission is internal to the sealed hub chamber.

Optionally, the transmission comprises a planetary transmission selectively operable according to a plurality of different transmission ratios.

Optionally, the transmission comprises a planetary transmission as well as a continuously variable transmission. Optionally, the planetary transmission is connected in series to the continuously variable transmission.

Optionally, the transmission does not comprise a continuously variable transmission, but only comprises a planetary transmission. Optionally, the transmission does not comprise a planetary transmission, but only comprises continuously variable transmission.

Optionally, the planetary transmission is arranged within the sealed hub chamber. For example, the transmission may comprise a continuously variable transmission and a planetary transmission. Herein the continuously variable transmission may be arranged external to the sealed hub chamber, and the planetary transmission may be arranged internal to the sealed hub chamber.

Optionally, the hub assembly comprises an intermediate drive part having an input connected to the driver and an output connected to the planetary transmission.

Optionally, the intermediate drive part extends between the intermediate drive part output internal to the sealed hub chamber and the intermediate drive part input external to the sealed hub chamber.

Optionally, the planetary transmission includes a first planetary gear set selectively operable according to a first transmission ratio and a second transmission ratio, and having a first clutch for switching from the first transmission ratio to the second transmission ratio and/or vice versa.

Optionally, the first planetary gear set comprises a sun gear, a ring gear, and a planet carrier carrying a planet gear. The first clutch may be arranged to effectively couple and decouple the planet carrier and the ring gear to/from one another. The first clutch may be arranged for coupling and/or decoupling under load. The first clutch may be similar or identical to a clutch as described in WO2018/199757A2, WO2020/085911A2, or WO2021/080431A1, hereby included by reference in their entirety.

Optionally, the first transmission ratio is unitary transmission ratio, and the second transmission ratio is a nonunitary transmission ratio, or vice versa. At unitary transmission ratio, an output speed of the transmission equals an input speed of the transmission. At nonunitary transmission ration, the output speed differs from the input speed of the transmission. A non-unitary transmission ratio may be speed-up, i.e. increasing the speed from the input to the output of the transmission, or speed-down, i.e. decreasing the speed from the input to the output of the transmission.

Optionally, the planetary transmission includes a second planetary gear set selectively operable according to a third transmission ratio and a fourth transmission ratio and having a second clutch for switching from the third transmission ratio to the fourth transmission ratio and/or vice versa.

Optionally, the second planetary gear set is a ringless planetary gear set including a sun gear and a planet carrier carrying a planet gear, or the second planetary gear set is a sunless planetary gear set including a ring gear and a planet carrier carrying a planet gear.

Optionally, the third transmission ratio is a unitary transmission ratio, and the fourth transmission is nonunitary transmission ratio, or vice versa.

Optionally, the second planetary gear set comprises a stepped planet gear having a small-radius part and a large-radius part. The small-radius part and the large radius-part may have respective external toothing for meshing with a ring gear and/or sun gear.

Optionally, the second planetary gear set is connected the first planetary gear set in series.

Optionally, the hub assembly comprises an electric propulsion motor connected to the hub shell. The electric propulsion motor can be arranged within the sealed hub chamber.

Optionally, the electric propulsion motor is connected to the hub shell via the transmission.

Optionally, the hub assembly comprises a reduction gear between the electric motor and the transmission input.

Optionally, the hub assembly comprises an axle extending longitudinally along the second axis between a drive side end near the driver and a non-drive side end opposite the drive side; and a torque support for supporting torque from the axle onto a frame of the bicycle. Optionally, the torque support is arranged at the drive side. The bicycle may for example be free of a, e.g. rear, derailleur.

Optionally, the torque support is configured for engaging a derailleur mount of the bicycle frame.

According to an aspect, a driver assembly is provided, comprising a first drive element connected to a sprocket; and a second drive element connectable to a hub shell, wherein the driver assembly is arranged for transmitting torque between the first drive element and the second drive element according to a selective transmission with a continuous range of transmission ratios. Hence, the driver assembly can form a continuously variable transmission between the sprocket and the hub shell. The second drive element may particularly be releasable couplable to the hub shell. This allows for replacement of a conventional driver with the driver assembly.

Optionally, the first drive element is rotatable about a first axis, and the second drive element is rotatable about a second axis, wherein the first drive element is movable relative to the second drive element in a direction transverse to the first and second axis; and wherein the driver assembly comprises coupling elements provided at a constant first radius from the first axis and at a variable second radius from the second axis, or at a constant first radius from the second axis and at a variable second radius from the first axis, for transferring torque between the first drive element and the second drive element.

Optionally, the coupling elements are coupled to the second drive element in a tangential direction, and movable relative to the second drive element in a radial direction, wherein the coupling elements are coupled to the first drive element in a radial direction at the first radius from the first axis, and movable relative to the first drive element in a first tangential direction, and wherein the coupling elements are couplable to the first drive element in a second tangential direction opposite the first tangential direction. It will be appreciated that any of the aspects, features and options described in view of the hub assembly apply equally to the driver assembly, and vice versa. It will particularly be appreciated that any of the aspects, features and options described in view of the driver of the hub assembly apply equally to the driver assembly, and vice versa.

According to an aspect, a wheel is provided, particularly a bicycle wheel, comprising a hub assembly and/or a driver assembly as described herein.

According to an aspect, a bicycle is provided comprising a wheel as described herein, and/or a hub assembly, and/or a driver assembly as described herein.

According to an aspect, a drive train for a bicycle is provided, comprising a hub assembly or a driver assembly as described herein, and further comprising a crank assembly comprising a crank, a sprocket, such as a chain ring, and a crank transmission arranged between the crank and the sprocket, selectively operable according to a plurality of different transmission ratios. The crank assembly may for example comprise an actuator for controlling the crank transmission. The controller may for example also control the transmission of the hub assembly.

Optionally, the crank assembly comprises an electric propulsion motor. The electric propulsion motor may drive the sprocket of the crank assembly, e.g. via the crank transmission.

It will be appreciated that any of the aspects, features and options described herein can be combined. It will particularly be appreciated that any of the aspects, features and options described in view of the hub assembly apply equally to the driver assembly, the wheel, the bicycle, and the drive train, and vice versa.

### BRIEF DESCRIPTION OF THE DRAWINGS

Embodiments of the present invention will now be described in detail with reference to the accompanying drawings in which:

FIGS. 1A and 1B show an example of a hub assembly;

FIGS. 2A and 2B show an example of a hub assembly;

FIGS. 3A and 3B show an example of a continuously variable transmission;

FIGS. 4A-4D show an example of a continuously variable transmission;

FIGS. 5A-5C show an example of a hub assembly;

FIGS. 6A and 6B show an example of a hub assembly;

FIGS. 7A and 7B show an example of a hub assembly;

FIGS. 8A and 8B show an example of a hub assembly;

FIGS. 9A and 9B show an example of a hub assembly;

FIGS. 10A and 10B show an example of a hub assembly

FIG. 11A shows an example of a driver assembly;

FIG. 11B shows an example of a hub assembly;

FIG. 12 shows an example of a bicycle.

### DETAILED DESCRIPTION

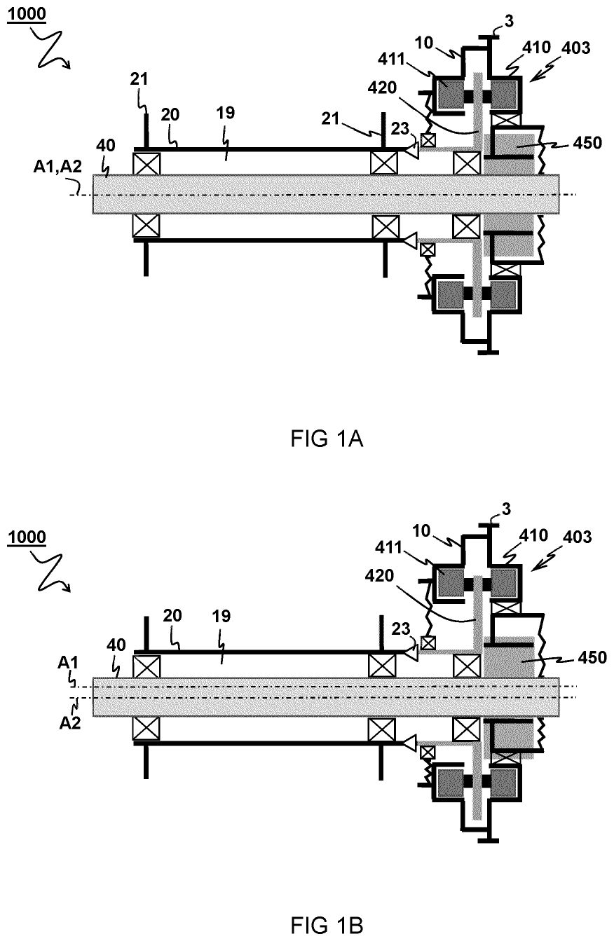

FIGS. 1A and 1B show a schematic example of a hub assembly 1000 for a bicycle wheel. The hub assembly 1000 includes a hub shell 20 for being mounted to a driven wheel of the bicycle. In this example, the hub shell 20 includes spokes flanges 21 for mounting of spokes of the wheel thereto. The hub shell 20 is rotatable about a second axis A2 which here corresponds to a rotation axis of the bicycle wheel. The hub assembly 1000, here, also includes an axle 40 which extends longitudinally along the second axis A2. The axle 40 may be mounted to a frame of the bicycle.

The hub assembly 1000 further includes a driver 10 connected to a sprocket 3. The driver 10 is rotatable about a first axis A1. The first axis A1 and the second axis A2 are parallel to each other. The first axis A1 and the second axis A2 may for example be coinciding.

The hub assembly 1000 also includes a transmission 30, operatively connected between the driver 10 and the hub shell 20. A user may drive the driver 10, e.g. via the sprocket 3, in rotation about the first axis A1, wherein the transmission 30 transmits torque from the driver 10 to the hub shell 20, so as to drive the hub shell 20, and in turn the bicycle wheel, in rotation about the second axis A2. The sprocket 3 may for example be meshing with a chain, belt or cardan to transfer torque from a crank and front chain ring of the bicycle to the driver 10.

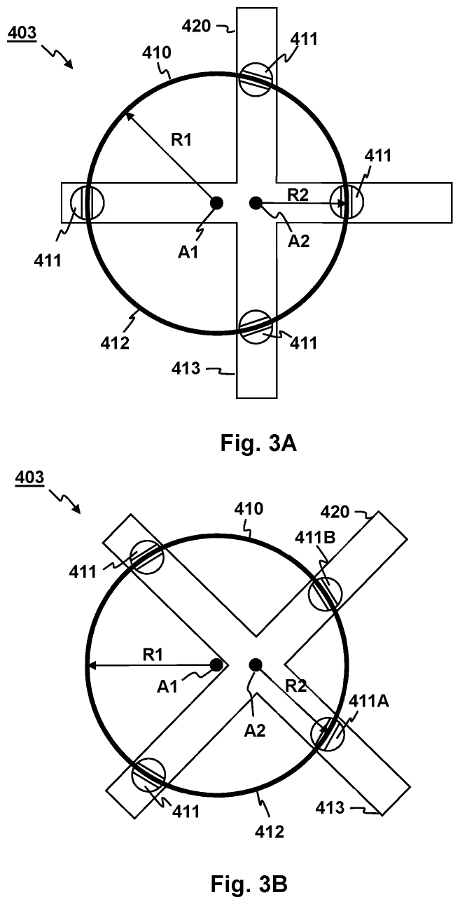

The transmission 30 in this example comprises a continuously variable transmission (CVT) 403. The CVT is, here particularly of a ratcheting type. FIGS. 3A and 3B schematically show a plan view of the CVT 403 as used in the example of FIGS. 1A and 1B. The CVT 403 includes a first drive element 410, here forming an input of the CVT 403, and a second drive element 420, here forming an output of the CVT 403. The first drive element 410 is rotatable about the first axis A1. The second drive element 420 is rotatable about a second axis A2. Torque can be transmitted from the first drive element 410 to the second drive element 420 by means of coupling elements 411. The coupling elements 411 are concentrically arranged with respect to the first axis A1, at a constant first radius R1 from the first axis A1. The first drive element 410 and the second drive element 420 are movable, e.g. translatable or pivotable, relative to one another in a direction transverse to the first and second axis A1, A2, e.g. for providing an offset between the first axis A1 and the second axis A2. Torque can be transmitted from the first drive element 410 to the second drive element 420, or vice versa, by means of the coupling elements 411, at a variable second radius R2 from the second axis A2. Hence, torque can be transferred from the constant first radius R1 to the variable second radius R2. Hence, various ratios between the first radius R1 and second radius R2 can be obtained, depending on the offset between the first drive element 410 and the second drive element 420, resulting in various transmission ratios between the first drive element 410 and the second drive element 420.

The hub assembly comprises an actuator 450, e.g. an electrically powered actuator, for actuating a movement the first drive element 410 relative to the second drive element 420 in a direction transverse to the second axis A2.

Here, the first drive element 410 is associated with, e.g. integrated with, the driver 10. Also, here, the second drive element 420 is associated with, e.g. integrated with, the hub shell 20. It will be appreciated that it is also possible that the first drive element 410 is associated with, e.g. integrated with, the hub shell 20 and the second drive element 420 is associated with, e.g. integrated with, the driver 10. The driver 10 is in this example movable relative to the hub shell 20 in a direction transverse to the first and second axes A1, A2, so as to change a transmission ratio of the CVT 403 that acts between the driver 10 and the hub shell 20. FIG. 1A shows the driver 10, being here integrated with the first drive element 410 of the CVT 403, in a concentric position relative to the hub shell 20, being here integrated with the second drive element 420 of the CVT 403. In the concentric position, the first axis A1 coincides with the second axis A2. In the concentric position, the CVT 403 operates according to unitary transmission ratio, i.e. a 1:1 ratio. The driver 10 is movable from the concentric position as shown in FIG. 1A to an eccentric position relative to the hub shell 20, as shown in FIG. 1B. In the eccentric position, the first axis A1 is offset from the second axis A2. In the eccentric position, the CVT 403 operates according to a nonunitary transmission ratio, in particular a speed-up ratio.

Although the CVT 403 may include one or more freewheels that allow for coasting, the hub assembly 1000 may include, e.g. an additional, freewheel 23 for increased coasting efficiency.

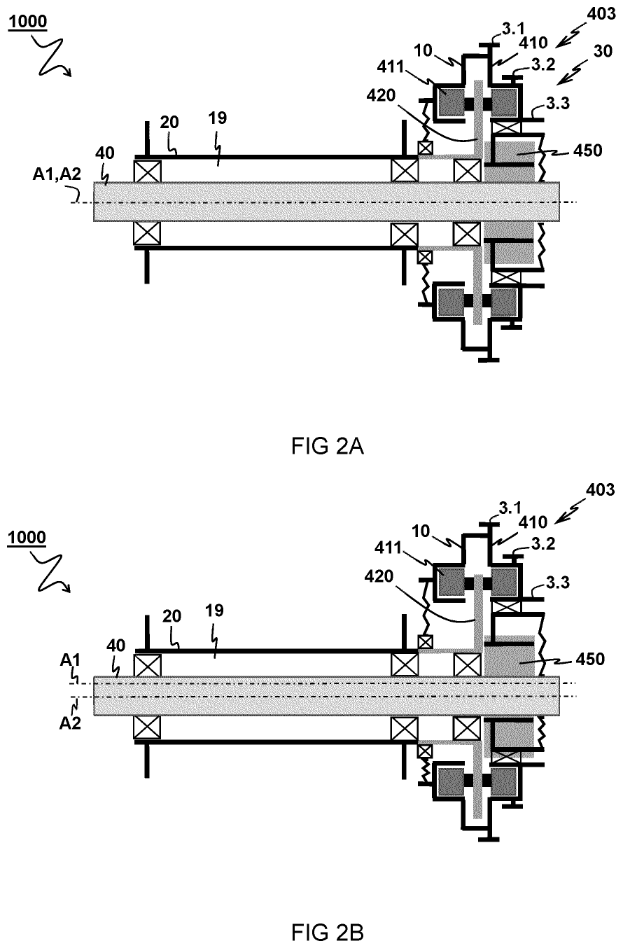

FIGS. 2A and 2B are similar to FIGS. 1A and 1B respectively, but differ by comprising more than a single sprocket 3, in this example three differently sized sprockets 3.1-3.3. In the example of 2A, 2B, the sprockets 3.1-3.3, the driver 10, and the first drive element 410 of the CVT 403 are integrated. The additional sprockets provide an increase in the range of obtainable transmission ratios. A derailleur may be provided for switching a chain from one sprocket to another. In the example of FIGS. 1A and 1B, a derailleur may be omitted.

With particular reference to FIGS. 3A and 3B, the coupling elements 411 are movable with respect to the first drive element 410 in a tangential direction. The first drive 410 element in this example comprises a first concentric guide 412 which extends concentrically around the first axis A1 at the first radius R1. Tangential movement of the coupling elements 411 about the first axis A1 is guided by the concentric guide 412. The concentric guide 412 prohibits a radial movement of the coupling elements 411 relative to the first axis A1, for keeping the coupling elements 411 at the constant first radius R1 from the first axis A1. The coupling elements are thus radially coupled to the first drive element 410, relative to the first axis A1.

With respect to the first axis A1, the coupling elements 411 are tangentially couplable to the first drive element 410. Hereto, in this example, the coupling elements 411 and the first concentric guide 412 form or include a one-way coupling. The one-way coupling is arranged for allowing tangential movement of the coupling elements 411 relative to the first concentric guide 412 in one direction, and for blocking tangential movement of the coupling elements 411 relative to the first concentric guide 412 in the other, opposite, direction. Hence, the first drive element 410 can drive the coupling elements 411 in rotation around the first axis A1 in one direction, while allowing the coupling elements 411 to freewheel relative to the first drive element 410 in the other direction.

The coupling elements 411 are furthermore movable relative to the second drive element 420 in a radial direction with respect to the second axis A2. In a tangential direction relative to the second axis A2, the coupling elements 411 are coupled to the second drive element 420. The second drive element 420 particularly comprises radial guides 413, e.g. radial slots, which extend radially with respect to the second axis A2. Here, the radial guides 413 are evenly and angularly spaced from each other. The coupling elements 411 are guided in radial direction, with respect to the second axis A2, by the radial guides 413.

In this example, CVT 403 comprises four coupling elements 411 associated with four respective radial guides 413, but it will be appreciated that the CVT 403 can comprise other than four radial guides 413, e.g. 3, 5, 6, 7, 8, 12, 16. Similarly, the CVT 403 can comprises other than four coupling elements 411, e.g. 3, 5, 6, 7, 8, 12, 16.

By moving the first drive element 410 relative to the second drive elements 420, in a direction perpendicular to the first and second axes A1, A2, a distance between the first axis A1 and the second axis A2 can be varied. Hence, a radius at which torque is transmitted can be varied.

In the example of FIGS. 3A and 3B, torque is transmitted from the first drive element 410 to the second drive element 420. FIGS. 3A and 3B show two relative angular positions of the first drive element 410 and the second drive element 420, with the same offset between the first axis A1 and the second axis A2. If the first drive element 410 is rotatingly driven in a driving direction about the first axis A1 (e.g. counter clockwise in this example), the coupling elements 411 are entrained in the rotation of the first drive element 410, and hence torque can be transmitted from the first drive element 410 to the second drive element 420. If the first drive element 410 is driven in the driving direction, all coupling elements 411 are forced to move with the first drive element 410 at a circumferential velocity that is at least equal to a circumferential velocity of the first concentric guide 412. If the first drive element 410 is driven in the driving direction, at least some of the coupling elements 411 can move at a circumferential velocity that is higher than the circumferential velocity of the first concentric guide 412. If the first drive element 410 is rotatingly driven in a non-driving direction about the first axis A1 opposite the driving direction (e.g. clockwise in this example), freewheeling of the coupling elements 411 is permitted, and hence no torque is transmitted from the first drive element 410 to the second drive element 420. In the driving direction of the first drive element 410, at least one of the coupling elements 411 transmits torque by coupling tangentially to the first drive element 410.

In particular, at a point in time only one of the coupling elements 411 transmits torque from the first drive element 410 to the second drive element 420, by coupling tangentially to the first drive element 410. The only one of the coupling elements 411 is radially coupled to the first drive element 410 by means of the concentric guide 412, and is tangentially coupled to the second drive element 420 by means of the radial guides 413. The coupling element of the coupling elements 411 being at a smallest second radius from the second axis A2 transmits torque. This coupling element is tangentially coupled to the first drive element 410, particularly by means of the one-way coupling of the coupling element 411 and the concentric guide 412. The coupling element that transmits torque has the lowest tangential velocity of the coupling elements 411. The other coupling elements are at a larger second radius R2 from the second axis A2, and therefore have a larger tangential velocity, are overrun the concentric guide 412 in tangential direction and hence do not transmit torque.

The second radius R2 from the second axis A2 at which torque is transmitted can be varied by the offset the first and second axes A1, A2.

FIG. 3B shows a situation in which the smallest second radius R2 is identical for the coupling elements 411A and 411B. This situation constitutes the hand-over point where the coupling element 411A just starts to transmit torque and the coupling element 411B just stops transmitting torque.

The CVT 403 is programmable to be operable according to any transmission ratio within a continuous CVT transmission ratio range. In this example, the CVT 403 is operable according any transmission ratio within a continuous range of 1 to about 1.7, e.g. 1 to about 1.5. However, other ranges are conceivable. The CVT 403 can be controlled to selectively operate at a preprogrammed set of one of two, three, four, five, or more distinct transmission ratios within the range.

The first drive element 410 may particularly be pivotable between the concentric position in which the first and second axis A1, A2 coincide, and the eccentric position in which the first and second axis A1, A2 are offset. The first drive element 410 may be pivotable about a pivot axis 426. The pivot axis may be arranged at a fixed distance from the second axis A2.

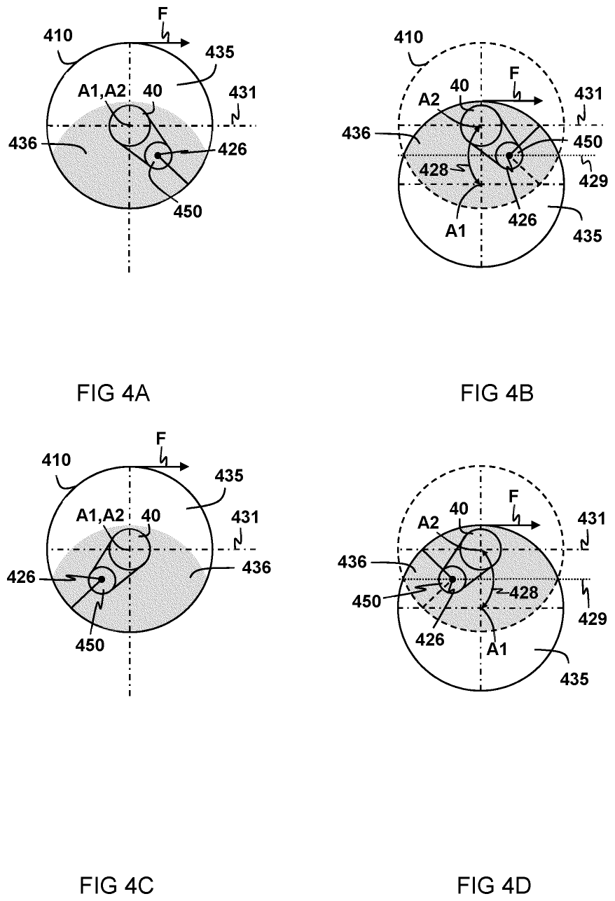

FIGS. 4A-4D schematically show a cross-sectional view of the hub assembly 1000 in a plane transverse to the second axis A2, particularly of the movable first drive element 410 of the CVT 403 relative the second axis A2. The hub assembly 1000 is shown to comprise an axle 40, which extends along the second axis A2. A force F can be applied to the first drive element 410 as indicated by the arrow in FIGS. 4A-4D, inducing a torque about the first axis A1. The torque rotatably drives the first drive element 410 in a clockwise direction in this example. The force F may be applied by a chain or belt that engages the sprocket 3, e.g. being is fixedly mounted to the first drive element 410. The direction of the indicated force F corresponds, in this example, to an intended drive direction of the bicycle.

The first drive element 410 is in the examples of FIGS. 4A-4D pivotable about a pivot axis 426. FIGS. 4A and 4C show the first drive element 410 to be in the concentric position, in which first and second axis A1, A2, align. In the concentric position, the torque transmission from the first drive element 410 to the second drive element 420 is according to a unitary transmission ratio. FIGS. 4B and 4D show the first drive element 410 in a eccentric end position, in which the first axis A1 is offset from the second axis A2. The first drive element 410 can be selectively positioned in any position within a continuous pivot range of positions 428, which pivot range is defined between the concentric position as shown in FIGS. 4A and 4C and the eccentric position as shown in FIGS. 4B and 4D. The continuous pivot range is indicated by the double arrow 428. In this example, the pivot axis 426 is offset from a plane 431 through the second axis A2, which plane 431 extends parallel to the intended drive direction. In the examples of FIGS. 4A-4D, the pivot axis 426 is below said plane 431, but it will be appreciated that the pivot axis 426 may also be above said plane 431. It will also be appreciated that the pivot axis 426 may alternatively be within said plane 431. The continuous pivot range 428 is in this example symmetrical with respect to a plane 429 through the pivot axis 426, which plane 429 extends parallel to the intended drive direction. Said plane 429 is in practice a horizontal plane.

In the example of FIGS. 4A and 4B, the pivot axis 426 is at a leading side of the first axis A1 with respect to the intended drive direction. Hence, in this example, the first drive element 410 is pivoted from the concentric position to the eccentric position in a direction substantially opposite the torque direction induced by force F on the first drive element 410. In the example of FIGS. 4C and 4D, the pivot axis 426 is at a trailing side of the first axis A1 with respect to the intended drive direction. Hence, in this example, the first drive element 410 is pivoted from the concentric position to the eccentric position in a direction substantially corresponding to the torque direction induced by force F on the first drive element 410.

The first drive element 410 forms a center cavity 435, here a circular center cavity, for allowing the axle 40 to extend therethrough. An intersection space 436 is defined as the intersection of the center cavity 435 when the first drive element 410 is in the concentric position and the center cavity 435 when the first drive element is in the eccentric position. Hence, as schematically shown in FIGS. 4B and 4D, the, here, circular center cavity 435 is displaceable between the concentric position and eccentric end position. The area of overlap between the center cavity 435 at either end of the pivot range defines the intersection space 436. It will be appreciated that, since the first drive element 410 is movable transverse to the first and second axis A1, A2, the intersection space 436 may extend parallel to the first and second axes A1, A2. Hence, the intersection space 436 may be substantially cylindrically shaped, i.e. having a constant cross-section in a plane transverse to the first and second axis. The hub assembly comprises an actuator 450, e.g. an electrically powered actuator, for actuating a movement the first drive element 410 relative to the second drive element 420 in a direction transverse to the second axis A2. The actuator 450 is in this example positioned in the intersection space 436. The actuator 450 is here particularly arranged to pivot the first drive element 410 about the pivot axis 426. In this example, the actuator 450 is coupled to the axle 40 for supporting torque thereon.

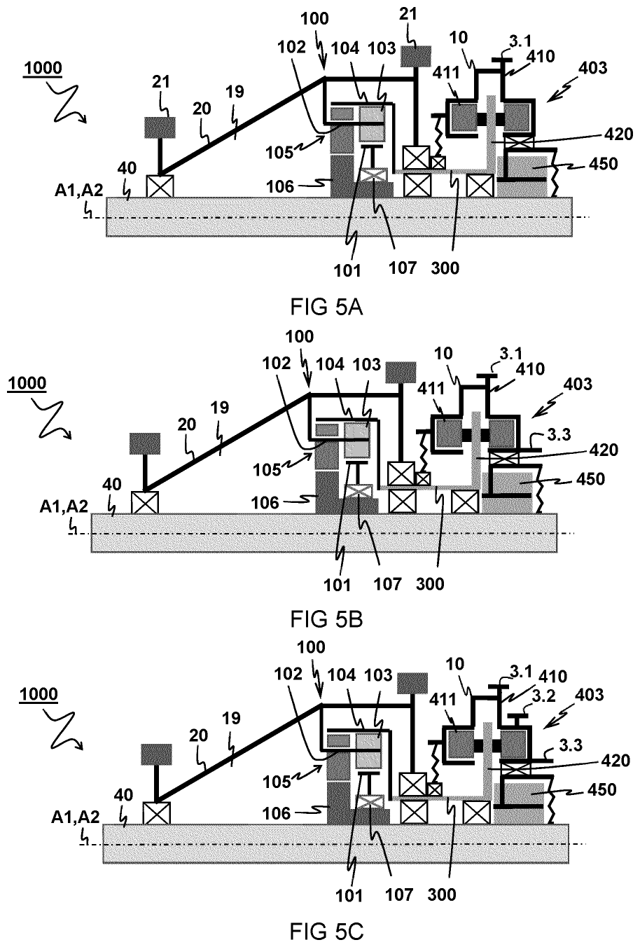

FIGS. 5A, 5B, and 5C show an example of a hub assembly 1000, comprising a CVT 403 similar to as shown in FIGS. 1A, 1B, 2A and 2B respectively. In the example of FIG. 5B, the assembly 1000 includes two sprockets 3.1 and 3.3, here having respectively 34 and 14 teeth, instead of three sprockets as shown in the example of FIG. 2B. The assembly 1000 comprises in this example a further transmission, here a planetary transmission including a first planetary gear set 100. The CVT 403 is connected to the first planetary gear set 100 in series. The planetary gear set 100 can increase the range of gears obtainable with the hub assembly 1000. The first planetary gear set 100 is arranged within a sealed hub chamber 19 formed by the hub shell 10. The sealed hub chamber 19 can be sealed against debris, preferably against dust, more preferably against liquid, such as water. The CVT 403 is here arranged external to the sealed hub chamber 19. An intermediate drive part 300 connects the CVT 403 with the first planetary gear set 100. The intermediate drive part 300 extends between an input connected to the CVT 403 and an output connected to the first planetary gear set 100, wherein the input is external to the sealed hub chamber 19 and the output is internal to the sealed hub chamber 19.

The first planetary gear set 100 comprises in this example a sun gear 101, a planet carrier 102 carrying a planet gear 103, and a ring gear 104. The intermediate drive part 300 is connected, at its output, to the ring gear 104. Hence, the ring gear 104 forms in this example an input of the first planetary gear set 100. An output of the first planetary gear set 100 is formed by the planet carrier 102, which is connected to the hub shell 10. The planetary gear set 100 is in this example operable according two different transmission ratios, here including a unitary transmission ratio and a nonunitary transmission ratio such as reduction ratio. A clutch 105 is arranged for switching between the two transmission ratios of the planetary gear set 100. An electro-mechanical actuator 106 may be provided for operating the clutch 105. The clutch 105 may particularly be arranged to switch between a coupled state and an uncoupled state under load. The clutch 105 may for example be clutch as described in WO2018/199757A2, WO2020/085911A2, or WO2021/080431A1, which are incorporated by reference in their entirety. The first planetary gear set 100 may operate at unitary transmission ratio in a coupled state of the clutch 105, effectively rotationally coupling the ring gear 104 to the planet carrier 102. The sun gear 101 may freewheel about the axle 40, via a freewheel 107. The first planetary gear set 100 may operate at nonunitary transmission ratio, e.g. a reduction ratio smaller than one, in a decoupled state of the clutch 105. In the decoupled state the ring gear 104 and the planet carrier 102 are rotatable about the second axis A2 at different speeds. In the decoupled state, the sun gear 101 couples to the axle 40 by the freewheel 107.

In particular, the hub assembly 1000 such as shown in FIG. 5A, comprising a single sprocket, the CVT 403, and the first planetary gear set 100, may for example provide a full group set for a bicycle, having six different gears. A front derailleur may be omitted. Table 1 shows an example of transmission ratios obtainable by a hub assembly 1000 as shown in FIG. 5A, in which R_1 denotes the transmission ratio of the first planetary gear set 100, and R_CVT the transmission ratio of the CVT 403.

TABLE 1

| R_1 | R_CVT | System transmission ratio | Step |
|---|---|---|---|
| 0.63 | 1.00 | 0.63 | |
| 0.63 | 1.17 | 0.74 | 1.17 |
| 0.63 | 1.36 | 0.86 | 1.16 |
| 1.00 | 1.00 | 1.00 | 1.16 |
| 1.00 | 1.18 | 1.18 | 1.18 |
| 1.00 | 1.39 | 1.39 | 1.18 |

Hence a six-speed transmission is obtained. Table 2 shows another example of transmission ratios obtainable by a hub assembly 1000 as shown in FIG. 5A, for obtaining a five-speed transmission.

TABLE 2

| R_1 | R_CVT | System transmission ratio | Step |
|---|---|---|---|
| 0.63 | 1.00 | 0.63 | |
| 0.63 | 1.28 | 0.81 | 1.29 |
| 1.00 | 1.00 | 1.00 | 1.23 |
| 1.00 | 1.20 | 1.20 | 1.20 |
| 1.00 | 1.39 | 1.39 | 1.16 |

The CVT 403 may be preprogrammed to switch between distinct transmission ratios such as given in the tables above, within its continuous range of transmission ratios. Alternatively, the CVT may sweep over its continuous range of transmission ratios, providing a smooth change of the transmission ratio, in between the steps of the first planetary gear set 100.

Table 3 and table 4 show two respective examples of transmission ratios obtainable by a hub assembly 1000 as shown in FIG. 5B.

TABLE 3

| Sprocket | R_1 | R_CVT | System transmission ratio | step |
|---|---|---|---|---|
| 34 teeth | 0.64 | 1.00 | 0.64 | |
| 34 teeth | 0.64 | 1.16 | 0.74 | 1.16 |
| 34 teeth | 0.64 | 1.35 | 0.86 | 1.16 |
| 34 teeth | 1.00 | 1.00 | 1.00 | 1.16 |
| 34 teeth | 1.00 | 1.16 | 1.16 | 1.16 |
| 34 teeth | 1.00 | 1.35 | 1.35 | 1.16 |
| 14 teeth | 0.64 | 1.00 | 1.56 | 1.15 |
| 14 teeth | 0.64 | 1.16 | 1.80 | 1.16 |
| 14 teeth | 0.64 | 1.35 | 2.10 | 1.16 |
| 14 teeth | 1.00 | 1.00 | 2.43 | 1.16 |
| 14 teeth | 1.00 | 1.16 | 2.82 | 1.16 |
| 14 teeth | 1.00 | 1.35 | 3.28 | 1.16 |
| | | | | Total: |
| | | | | 5.28 |

TABLE 4

| Sprocket | R_1 | R_CVT | System transmission ratio | step |
|---|---|---|---|---|
| 34 teeth | 0.64 | 1.00 | 0.64 | |
| 34 teeth | 0.64 | 1.12 | 0.71 | 1.11 |
| 34 teeth | 0.64 | 1.25 | 0.80 | 1.13 |
| 34 teeth | 0.64 | 1.39 | 0.89 | 1.11 |
| 34 teeth | 1.00 | 1.00 | 1.00 | 1.12 |
| 34 teeth | 1.00 | 1.12 | 1.12 | 1.12 |
| 34 teeth | 1.00 | 1.25 | 1.25 | 1.12 |
| 34 teeth | 1.00 | 1.39 | 1.39 | 1.11 |
| 14 teeth | 0.64 | 1.00 | 1.56 | 1.12 |
| 14 teeth | 0.64 | 1.12 | 1.74 | 1.12 |
| 14 teeth | 0.64 | 1.25 | 1.94 | 1.11 |
| 14 teeth | 0.64 | 1.39 | 2.16 | 1.11 |
| 14 teeth | 1.00 | 1.00 | 2.43 | 1.11 |
| 14 teeth | 1.00 | 1.12 | 2.71 | 1.13 |
| 14 teeth | 1.00 | 1.25 | 3.03 | 1.11 |
| 14 teeth | 1.00 | 1.39 | 3.38 | 1.12 |
| | | | | Total |
| | | | | 5.28 |

Hence, respectively a 12-speed and 16-speed transmission ratio can be obtained. The example of FIG. 5B includes two sprockets, one of which having 34 teeth and one of which having 14 tooth. The change from sprocket 3.1, here having 34 teeth, to sprocket 3.3, here having 14 teeth, increases the range of system transmission ratios obtainable with the hub assembly 1000 by a factor 2.43. A derailleur can be used to switch a chain or belt between the sprockets.

Table 5 shows an example of transmission ratios obtainable by a hub assembly 1000 as shown in FIG. 5C, having three sprockets, particularly a 34-teeth sprocket, a 24 teeth sprocket and a 14-teeth sprocket.

TABLE 5

| Sprocket | R_1 | R_CVT | System transmission ratio | step |
|---|---|---|---|---|
| 34 teeth | 0.64 | 1 | 0.64 | |
| 34 teeth | 0.64 | 1.12 | 0.72 | 1.12 |
| 34 teeth | 0.64 | 1.25 | 0.80 | 1.12 |
| 34 teeth | 0.64 | 1.39 | 0.89 | 1.11 |
| 34 teeth | 1 | 1 | 1.00 | 1.12 |
| 24 teeth | 0.64 | 1.25 | 1.14 | 1.14 |
| 24 teeth | 0.64 | 1.39 | 1.26 | 1.11 |
| 24 teeth | 1 | 1 | 1.42 | 1.12 |
| 24 teeth | 1 | 1.12 | 1.59 | 1.12 |
| 24 teeth | 1 | 1.25 | 1.78 | 1.12 |
| 24 teeth | 1 | 1.39 | 1.97 | 1.11 |
| 14 teeth | 0.64 | 1.39 | 2.16 | 1.10 |
| 14 teeth | 1 | 1 | 2.43 | 1.12 |
| 14 teeth | 1 | 1.12 | 2.72 | 1.12 |
| 14 teeth | 1 | 1.25 | 3.04 | 1.12 |
| 14 teeth | 1 | 1.39 | 3.38 | 1.11 |
| | | | | Total: |
| | | | | 5.28 |

Hence, a 16-speed transmission is obtained with steps between consecutive transmission ratios of about 12%. Compared to the exemplary hub assembly 1000 of FIG. 5B, the additional 24-tooth sprocket provides an intermediate step in the relatively large gap between the 14-teeth and 34-teeth sprocket. This facilitates shifting of the chain between the sprockets.

Table 6 provides another example of transmission ratios obtainable by a hub assembly 1000 similar to the example of FIGS. 5A-5C, including a 24-teeth sprocket and a 14-teeth sprocket.

TABLE 6

| Sprocket | R_1 | R_CVT | System transmission ratio | step |
|---|---|---|---|---|
| 24 teeth | 0.64 | 1 | 0.64 | |
| 24 teeth | 0.64 | 1.12 | 0.72 | 1.12 |
| 24 teeth | 0.64 | 1.25 | 0.80 | 1.12 |
| 24 teeth | 0.64 | 1.39 | 0.89 | 1.11 |
| 24 teeth | 1 | 1 | 1.00 | 1.12 |
| 24 teeth | 1 | 1.12 | 1.12 | 1.12 |
| 14 teeth | 0.64 | 1.12 | 1.23 | 1.10 |
| 14 teeth | 0.64 | 1.25 | 1.37 | 1.12 |
| 14 teeth | 0.64 | 1.39 | 1.53 | 1.11 |
| 14 teeth | 1 | 1 | 1.71 | 1.12 |
| 14 teeth | 1 | 1.12 | 1.92 | 1.12 |
| 14 teeth | 1 | 1.25 | 2.14 | 1.12 |
| 14 teeth | 1 | 1.39 | 2.38 | 1.11 |
| | | | | Total |
| | | | | 3.72 |

It will be appreciated that the ratios of the above tables are given by way of example, and that other ratios are envisioned.

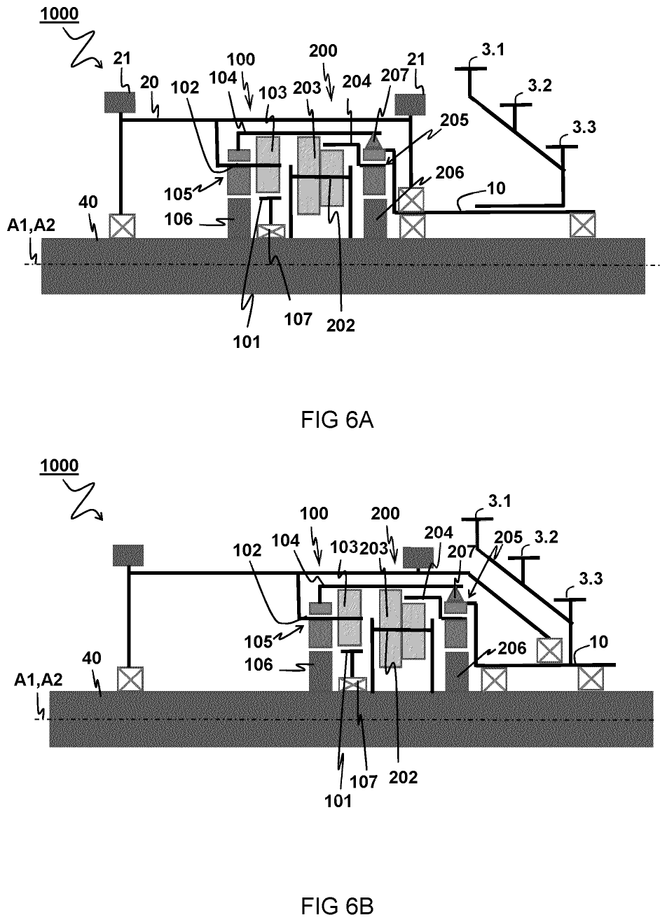

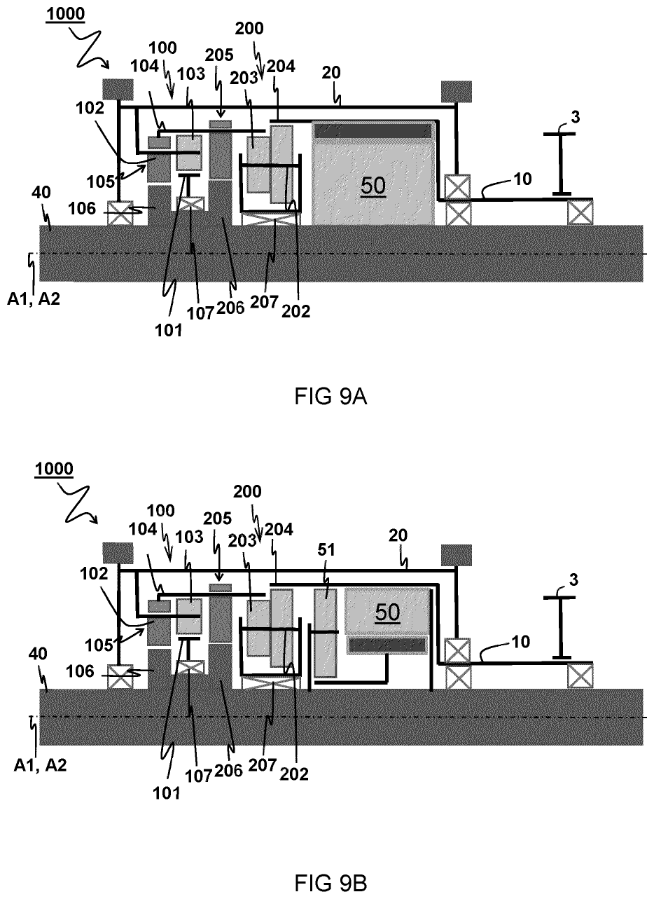

Instead of a two-speed or three-speed cassette of sprockets as shown in FIGS. 5B and 5C, the range of system transmission ratios obtainable with the hub assembly 1000 may alternatively be increased by providing a further transmission, such as a second planetary gear set 200 connected in series with the first planetary gear set 100. An example of such hub assembly 100 is shown in FIGS. 6A and 6B. FIGS. 6A and 6B show an example of a hub assembly 1000 wherein the planetary transmission comprises, in addition to the first planetary gear set 100, a second planetary gear set 200. The second planetary gear set 200 is connected in series with the first planetary gear set 100. In this example, an output of the second planetary gear set 200 is connected to an input of the first planetary gear set 100. It will be appreciated that this order may be reversed, i.e. that the output of the first planetary gear set 100 is connected to an input of the second planetary gear set 200. The first and second planetary gear sets 100, 200 are arranged within the sealed hub chamber 19. In this example, the hub assembly 1000 does not include a CVT 403. FIGS. 9A and 9B show an example of a hub assembly 1000 similar to the hub assembly 1000 as shown in FIGS. 6A,6B, further comprising a CVT 403.

In the example of FIGS. 6A, 6B, the second planetary gear set 200 is a sunless planetary gear set 200, comprising a planet carrier 202 carrying a planet gear 203, and a ring gear 204. The second planetary gear set 200 does not comprise a sun gear. Alternatively, the second planetary gear set 200 may be ringless, comprising a planet carrier 202 carrying a planet gear 203 and a sun gear 201, not comprising a ring gear.

The planet carrier 202 is fixedly mounted to the axle 40. The planet gear 203 is a stepped planet gear 203 having two rotationally coupled parts of different radii. Here, the small-radius part of the stepped planet gear 203 connects to the ring gear 204 of the second planetary gear set 200, whereas the large-radius part of the stepped planet gear 203 connects to the ring gear 104 of the first planetary gear set 100. Hence, here, the second planetary gear set 200 provides a nonunitary transmission ratio, particularly a speed-up transmission ratio. The second planetary gear set 200 also provides a unitary transmission ratio.

The second planetary gear set 200 comprises a clutch 205 arranged for switching between the two transmission ratios of the second planetary gear set 200. The clutch 205 may be similar or identical to the clutch 105 of the first planetary gear set 100. An electro-mechanical actuator 206 may be provided for operating the clutch 205. Like clutch 105, the clutch 205 may particularly be arranged to switch between a coupled state and an uncoupled state under load. The clutch 205 is arranged to effectively rotationally couple the driver 10, and/or intermediate drive part 300 coupled to the driver 10, to the ring gear 204 of the second planetary gear set 200. The driver 10, and/or intermediate drive part 300, is coupled to the ring gear 104 of the first planetary gear set via a freewheel 207. In a coupled state of the clutch 205, the driver 10, and/or intermediate drive part 300, and the ring gear 204 are rotationally coupled, causing freewheel 207 to be overrun when rotation of the driver 10 about the first axis A1 is transferred via the stepped planet gear 202 to the ring gear 104. In a decoupled state of the clutch 205, torque is transmitted through the freewheel 207 from the driver 10, and/or intermediate drive part 300, to the ring gear 104. In the decoupled state of the clutch 205, the freewheel 207 allows for coasting, to prevent the hub shell 20 from driving the driver 10 when no torque is applied to the driver 10 by the user.

Instead of a derailleur, the hub assembly 1000 may include an axially movable cassette of sprockets. The example of FIG. 6A shows an example where the cassette of, here three, sprockets 3.1-3.3 is movable in axial direction relative to the driver 10. Hence, a derailleur-free bicycle may be obtained.

FIGS. 6A and 6B show two respective positions of the planetary transmission on the axle 40. In the example of FIG. 6A, the planetary transmission, which includes the first planetary gear set 100 and the second planetary gear set 200, is axially spaced from the cassette of sprockets 3.1-3.3. In the example of FIG. 6B, the planetary transmission is arranged partially under the cassette of sprockets 3.1-3.3. Hence, in axial direction, the planetary transmission and the cassette of sprockets 3.1-3.3 partly overlap in the example of FIG. 6B.

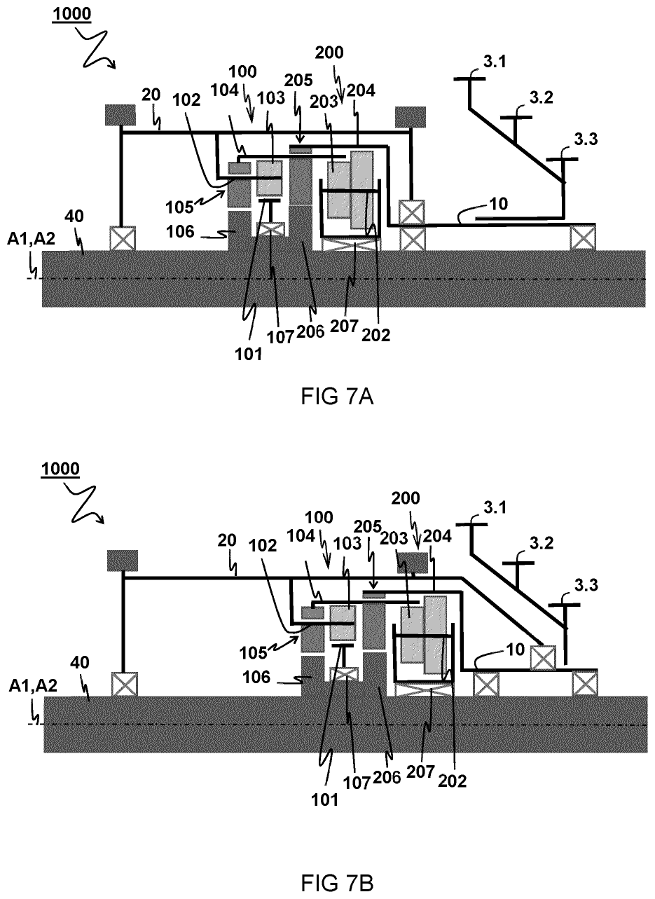

The examples of FIGS. 7A and 7B are similar to the examples as shown in FIGS. 6A and 6B respectively. Instead of a speed-up transmission ratio obtained with the second planetary gear set 200 in FIGS. 6A,6B, the second planetary gear set 200 of FIG. 7A, 7B includes a speed-down transmission ratio. Hence, here, the small-radius part of the stepped planet gear 203 connects to the ring gear 104 of the first planetary gear set 100, whereas the large-radius part of the stepped planet gear 203 connects to the ring gear 204 of the second planetary gear set 200. In the example of FIGS. 7A and 7B, the clutch 205 is arranged for coupling and decoupling the ring gear 204 to the ring gear 104. Here, in the coupled state, the ring gears 104, 204 are rotationally coupled to each other, providing a unitary transmission ratio for the second planetary gear set 200. In the decoupled state, the ring gears 104, 204, are rotationally decoupled, allowing a relative rotation therebetween. Torque is transmitted in the decoupled state from the ring gear 204 via the stepped planet gear 203 to the ring gear 104, providing a nonunitary, here a speed-down transmission ratio, for the second planetary gear set 200. In this example, a freewheel 207 is arranged between the planet carrier 202 and the axle 40. In the coupled state of the clutch 205, the freewheel 207 overruns, to allow the planet carrier 202 to rotate about the axle 40. In the decoupled state of the clutch 205, the freewheel 207 rotationally couples the planet carrier 202 to the axle 40. The freewheel 207 allows for coasting in the decoupled state of the clutch 205, to prevent the hub shell 20 from driving the driver 10 when no torque is applied to the driver 10 by the user.

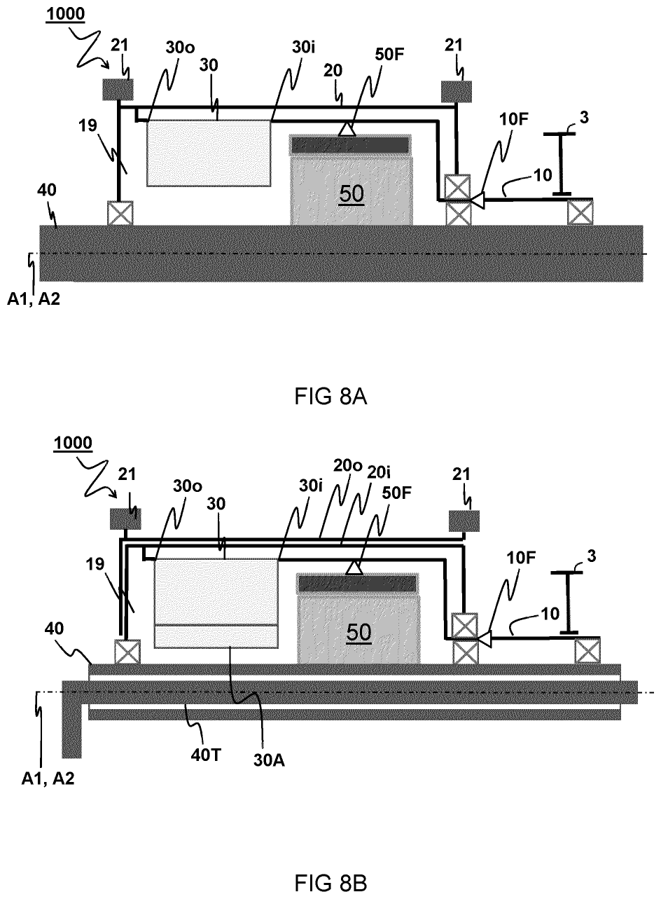

FIGS. 8A and 8B show a schematic example of a hub assembly 1000. The hub assembly 1000 includes a hub shell 20 for being mounted to a driven wheel of the bicycle. In this example, the hub shell 20 includes spokes flanges 21 for mounting of spokes of the wheel thereto. The hub shell 20 is rotatable about a second axis A2 which here corresponds to a rotation axis of the bicycle wheel. The hub assembly 1000, here, also includes an axle 40 which extends longitudinally along the second axis A2. The axle 40 may be mounted to a frame of the bicycle.

The hub assembly 1000 further includes a driver 10 connected to a sprocket 3, or a plurality of sprockets, e.g. of a cassette. The sprocket can be part of a cassette or set of sprockets including at most ten different sprockets, particularly at most eight different sprockets, more particular at most six different sprockets, more particular at most four different sprockets. The driver 10 is rotatable about a first axis A1. The first axis A1 and the second axis A2 are parallel to each other. The first axis A1 and the second axis A2 may for example be coinciding.

The hub assembly 1000 also includes a transmission 30, operatively connected between the driver 10 and the hub shell 20. A user may drive the driver 10, e.g. via the sprocket 3, in rotation about the first axis A1, wherein the transmission 30 transmits torque from the driver 10 to the hub shell 20, so as to drive the hub shell 20, and in turn the bicycle wheel, in rotation about the second axis A2. The sprocket 3 may for example be meshing with a chain, belt or cardan to transfer torque from a crank and front chain ring of the bicycle to the driver 10.

The transmission 30 in this example is selectively operable according to a plurality of different transmission ratios. Hence, torque can be transmitted from the driver 10 to the hub shell 20, so as to drive the hub shell 20, and in turn the bicycle wheel, in rotation according to a selected one of the plurality of transmission ratios. The transmission 30 is preferably electrically actuatable. The actuator 30A can also be comprised inside the hub shell 20. The actuator can be wiredly or wirelessly in communication with a controller and/or shifter. The hub assembly can comprise an antenna, e.g. arranged within the hub shell 20.

In this example, the hub assembly further includes an electric propulsion motor 50. The electric propulsion motor 50 is configured for propelling or assist in propelling the bicycle. Here, the electric propulsion motor 50 is coupled or couplable to the hub shell 20 via the transmission 30. In this example, the transmission 30 comprises a transmission input 30i and a transmission output 300. Here, the driver 10 is connected to the transmission input 30i for driving the transmission 30. Optionally, the driver 10 can be connected to the transmission input 30i for driving the transmission 30 via a freewheel, such as freewheel 10F. Here, the electric propulsion motor 50 is connected to the transmission input 30i for driving the transmission. Optionally, the electric propulsion motor 50 can be connected to the transmission input 30i for driving the transmission 30 via a freewheel, such as freewheel 50F. The transmission output 300 is connected to the hub shell 20 for driving the hub shell according to one of the plurality of transmission ratios. Here, the transmission 30 and the electric propulsion motor 50 are arranged within a hub chamber, such as a sealed hub chamber, 19 formed by the hub shell 20. A power supply line may be provided from an external of the hub chamber 19 to the electric propulsion motor 50, for supplying electric power. The electric propulsion motor 50 may have a stator that is rotationally coupled to the axle 40, a rotor that is rotatably arranged relative to the stator. The electric propulsion motor 50 in this example is concentric about the second axis A2.

In the example of FIG. 8B, the hub shell 20 comprises an inner part 20i housing the transmission 30 and in this example the electric propulsion motor 50, and an outer part 200 for being mounted to the bicycle wheel. In this example, the outer part 200 of the hub shell 20 includes spokes flanges 21 for mounting of spokes of the wheel thereto. The outer part 200 is removably mounted to the inner part 20i. For instance, the outer part 200 is radially supported by one or more radial supports of the inner part 20i. The outer part 200 may e.g. be rotationally coupled with respect to the inner part 20i, e.g. by a splined connection. The outer part 200 may e.g. be axially fixed relative to the inner part 20i by an axial stop. The outer part 200 may be fixated to the inner part 20i, e.g. by a screw thread, e.g. by a (for instance single) nut. Hence, the inner part 20i with the transmission 30 and electric propulsion motor 50 can be provided as a subassembly that can easily be mounted into the outer part 200. This can e.g. allow easy exchange of the outer part 200 with a different outer part for applying the transmission and electric propulsion motor to a different wheel. This can e.g. allow easy exchange of the inner part 20i with a different inner part for providing a wheel with a different transmission and electric propulsion motor. It will be appreciated that the inner part 20i and outer part 200 can also be applied to the other examples of hub assemblies shown herein.

In the example of FIG. 8B the axle 40 is a hollow wheel axle. In this example, a thru-axle 40T is provided, extending through the hollow wheel axle 40, for easily mounting the hub assembly 100 to the frame of a bicycle. It will be appreciated that the thru-axle can also be applied to the other examples of hub assemblies shown herein.

FIGS. 9A and 9B show an example of a hub assembly 1000, similar to the example as shown in FIGS. 8A. 8B, and similar to the example as shown in FIGS. 7A, 7B, and further including an electric propulsion motor 50. The electric propulsion motor 50 is configured for propelling or assist in propelling the bicycle. Here, the electric propulsion motor 50 is coupled or couplable to the input of the planetary transmission, particularly to the second planetary gear set 200. In the example of FIG. 8A, the electric propulsion motor 50 is coupled directly to the ring gear 204, whereas in the example of FIG. 8B, electric propulsion motor 50 is coupled via a reduction gear 51 to the ring gear 204. It will be appreciated that a reduction between the electric propulsion motor 50 and the hub shell 20 can also be applied in the example of FIGS. 8A and 8B. Here, the electric propulsion motor 50 is arranged within the sealed hub chamber 19 formed by the hub shell 20. A power supply line may be provided from an external of the sealed hub chamber 19 to the electric propulsion motor 50, for supplying electric power. The electric propulsion motor 50 may have a stator that is rotationally coupled to the axle 40, a rotor that is rotatably arranged relative to the stator.

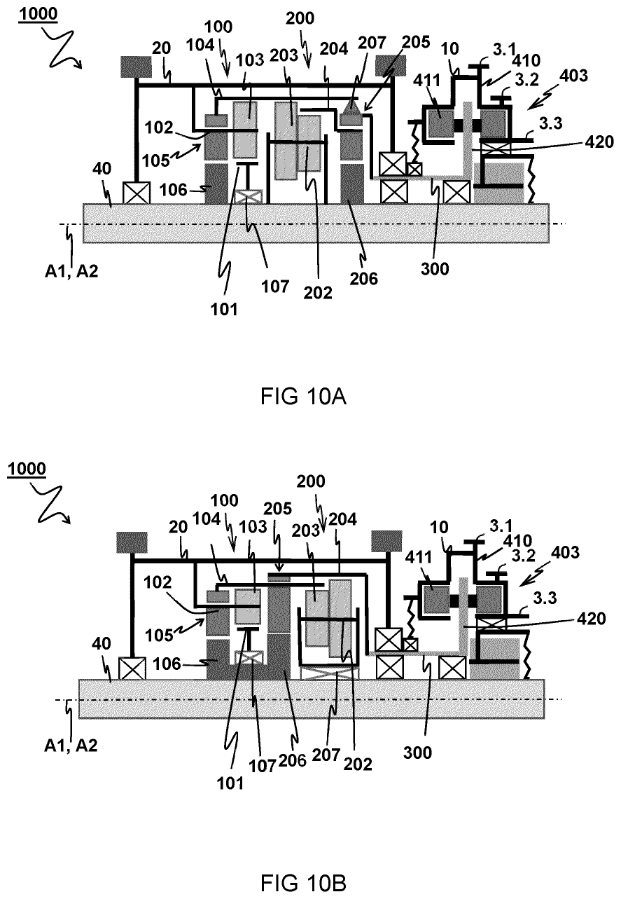

FIGS. 10A and 10B show an example of a hub assembly 1000, comprising a CVT 403 as shown in FIGS. 1A, 1B and 2A,2B, and a planetary transmission including the first planetary gear set 100 and the second planetary gear set 200 as shown in FIGS. 6A,6B and 7A,7B. The hub assembly 1000 as shown in FIGS. 10A, 10B is similar to the example of FIGS. 5A, 5B and 5C, but further includes a second planetary gear set 200. The second planetary gear set 200 of the example of FIG. 9A is similar to the second planetary gear set 200 as shown in FIGS. 6A,6B. The second planetary gear set 200 of the example of FIG. 10B is similar to the second planetary gear set 200 as shown in FIGS. 7A,7B. The planetary transmission is arranged within the sealed hub chamber 19, formed by the hub shell 20, and the CVT 403 is arranged external to the sealed hub chamber 19. Although in FIGS. 9A and 9B the assembly 1000 is shown to include a single sprocket 3.1, it will be appreciated that also more than one sprocket can be used.

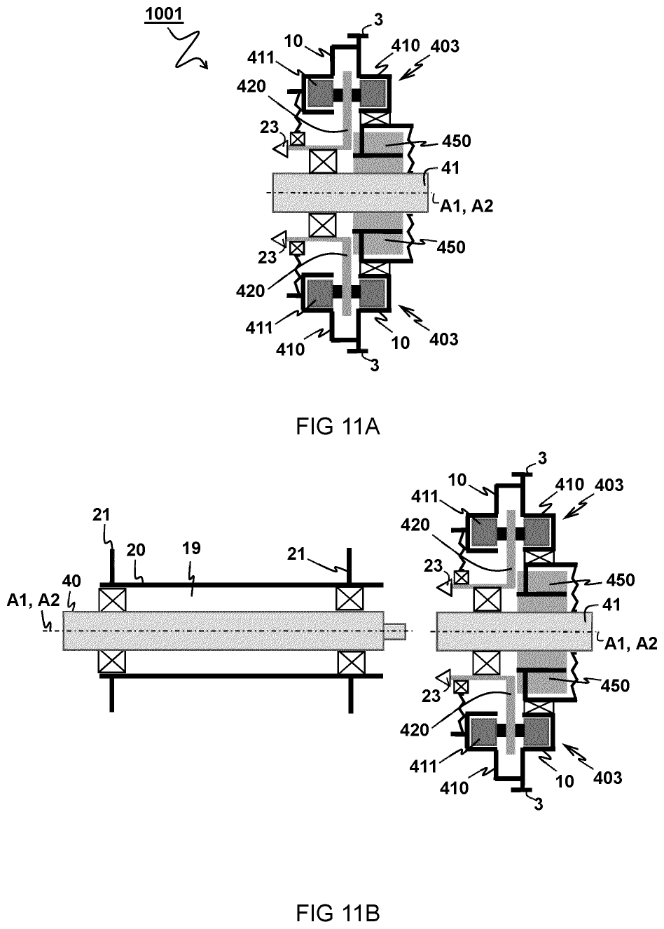

FIG. 11A shows a driver assembly 1001, comprising the first drive element 410 and the second drive element 420 as described herein. The first drive element 410 is connected to the sprocket 3, and the second drive element 420 is releasably connectable to the hub shell 20. Here, the driver assembly 1001 includes a first axle part 41. FIG. 11B shows the driver assembly 1001 of FIG. 11A, being couplable to the hub shell 20, so as form the hub assembly 1000 as described herein. Here, the hub shell 20 is associated with a second axle part 42. The first axle part 41 and the second axle part 42 can be releasably coupled to each other to form the axle 40. Hence, the driver assembly 1001 can remain attached to the bicycle frame when removing the wheel and the hub shell 20, facilitating wheel replacement action.

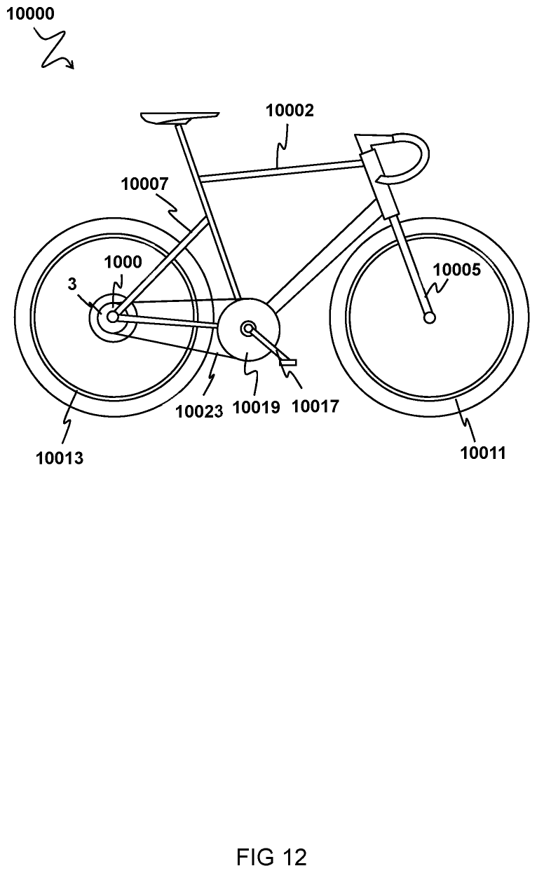

FIG. 12 shows a bicycle 10000. The bicycle 10000 comprises a frame 10002 with a front fork 10005 and a rear fork 10007, as well as a front wheel and a rear wheel 10011, 10013 located in the front and rear fork respectively. The bicycle 10000 further comprises a crank 10017, and a front chain wheel 10019. The comprises a hub assembly 1000, such as described herein. The bicycle 10000 also comprises a sprocket 3, wherein a chain 10023 threads over the front chain wheel 10019 and rear sprocket 10021. The bicycle is, here, free of a derailleur.

Concise and general descriptions of certain aspects as described hereinabove are now summarized as numbered embodiments.

Embodiment 1. Hub assembly for a bicycle wheel, comprising
a driver, rotatable about a first axis, for being mounted to a sprocket;
a hub shell, rotatable about a second axis parallel to the first axis, for being mounted to the bicycle wheel;
a transmission selectively operable according to a plurality of different transmission ratios, and operatively connected between the driver and the hub shell.

Embodiment 2. Hub assembly of embodiment 1, wherein the transmission comprises a continuously variable transmission selectively operable according to a plurality of transmission ratios within a continuous range of transmission ratios.

Embodiment 3. Hub assembly of embodiment 2, wherein the continuously variable transmission is of ratchet type, having freewheel or one-way drive elements.

Embodiment 4. Hub assembly of embodiment 2 or 3, wherein the continuously variable transmission is arranged to change the ratio under load.

Embodiment 5. Hub assembly of any of embodiments 2-4, wherein the continuously variable transmission includes
a first drive element connected to the driver and rotatable about the first axis;
a second drive element connected to the hub shell and rotatable about the second axis, the first drive element being movable relative to the second drive element in a direction transverse to the first and second axis;
coupling elements provided at a constant first radius from the first axis and at a variable second radius from the second axis, or at a constant first radius from the second axis and at a variable second radius from the first axis, for transferring torque between the first drive element and the second drive element.

Embodiment 6. Hub assembly of embodiment 5, wherein the first drive element is fixed to or integrated with the driver.

Embodiment 7. Hub assembly of embodiment 5 or 6, wherein the second drive element is coupled or couplable to the hub shell.

Embodiment 8. Hub assembly of any of embodiments 5-7, comprising an axle having a first axle part and a second axle part, wherein the first drive element is arranged to rotate about the first axle part, and hub shell is arranged to rotate about the second axle part, wherein the first axle part and the second axle part are detachably connected to each other.

Embodiment 9. Hub assembly of embodiment 8, wherein the first axle part is arranged to be fixed to a frame of the bicycle, particularly to a dropout of the bicycle frame, more particular to a right-side dropout of the bicycle frame.

Embodiment 10. Hub assembly of any of embodiments 5-9, comprising a freewheel between the second drive element and the hub shell.

Embodiment 11. Hub assembly of any of embodiments 5-10, wherein the coupling elements are coupled to the second drive element in a tangential direction, and movable relative to the second drive element in a radial direction,
wherein the coupling elements are coupled to the first drive element in a radial direction at the first radius from the first axis, and movable relative to the first drive element in a first tangential direction, and wherein the coupling elements are couplable to the first drive element in a second tangential direction opposite the first tangential direction.

Embodiment 12. Hub assembly of any of embodiments 5-11, wherein the first drive element is pivotally movable about a pivot axis that extends parallel to the first axis, for being pivotally moved, between first and second extreme positions, relative to the second drive element in a direction transverse to the first axis.

Embodiment 13. Hub assembly of embodiment 12, wherein the first extreme position is a concentric position in which the first axis coincides with the second axis, and wherein the second extreme position is an eccentric position in which the first axis is offset from the second axis.

Embodiment 14. Hub assembly of embodiment 12 or 13, wherein the first drive element is pivotable about the pivot axis to a selective position within a continuous pivot range, e.g. defined between the first and second extreme positions, wherein the continuous pivot range is symmetrical with respect to a horizontal plane through the pivot axis.

Embodiment 15. Hub assembly of any of embodiments 12-14, wherein with respect to an intended drive direction of the bicycle, the pivot axis is arranged at a trailing side of the second axis.

Embodiment 16. Hub assembly of any of embodiments 12-15, wherein the first drive element forms a center cavity for allowing an axle to extend therethrough, wherein the pivot axis is arranged in an intersection space, which intersection space is defined as the intersection of the center cavity when the first drive element is in the first extreme position and the center cavity when the first drive element is in the second extreme position.

Embodiment 17. Hub assembly of embodiment 16, wherein the hub assembly comprises an actuator for actuating a movement of the first drive element relative to the second drive element in a direction transverse to the second axis, wherein the actuator is arranged in the intersection space.

Embodiment 18. Hub assembly of any of embodiments 1-17, comprising a sealed hub chamber formed by the hub shell.

Embodiment 19. Hub assembly of embodiment 18 insofar as at least dependent from embodiment 2, wherein the continuously variable transmission is external to the sealed hub chamber.

Embodiment 20. Hub assembly of any of embodiments 1-19, wherein the transmission comprises a planetary transmission selectively operable according to a plurality of different transmission ratios.

Embodiment 21. Hub assembly of embodiment 20 insofar as dependent on embodiment 2, wherein the planetary transmission is connected in series to the continuously variable transmission.

Embodiment 22. Hub assembly of embodiment 20 or 21 insofar as at least dependent on embodiment 18, wherein the planetary transmission is arranged within the sealed hub chamber.

Embodiment 23. Hub assembly of any of embodiments 20-22, comprising an intermediate drive part having an input connected to the driver and an output connected to the planetary transmission.

Embodiment 24. Hub assembly of embodiment 23, wherein the intermediate drive part extends between the intermediate drive part output internal to the sealed hub chamber and the intermediate drive part input external to the sealed hub chamber.

Embodiment 25. Hub assembly of any of embodiments 20-24, wherein the planetary transmission includes a first planetary gear set selectively operable according to a first transmission ratio and a second transmission ratio and having a first clutch for switching from the first transmission ratio to the second transmission ratio and/or vice versa.

Embodiment 26. Hub assembly of embodiment 25, wherein the first planetary gear set comprises a sun gear, a ring gear, and a planet carrier carrying a planet gear.

Embodiment 27. Hub assembly of embodiment 25 or 26, wherein the first transmission ratio is unitary transmission ratio, and the second transmission ratio is a nonunitary transmission ratio, or vice versa.

Embodiment 28. Hub assembly of any of embodiments 20-27, wherein the planetary transmission includes a second planetary gear set selectively operable according to a third transmission ratio and a fourth transmission ratio and having a second clutch for switching from the third transmission ratio to the fourth transmission ratio and/or vice versa.

Embodiment 29. Hub assembly of embodiment 28, wherein the second planetary gear set is a ringless planetary gear set including a sun gear and a planet carrier carrying a planet gear, or wherein the second planetary gear set is a sunless planetary gear set including a ring gear and a planet carrier carrying a planet gear.

Embodiment 30. Hub assembly of embodiment 28 or 29, wherein the third transmission ratio is a unitary transmission ratio, and the fourth transmission is nonunitary transmission ratio, or vice versa.

Embodiment 31. Hub assembly of any of embodiments 28-30, wherein the second planetary gear set comprises a stepped planet gear having a small-radius part and a large-radius part.

Embodiment 32. Hub assembly of any of embodiments 28-31, wherein the second planetary gear set is connected the first planetary gear set in series.

Embodiment 33. Hub assembly of embodiment 18 or any of embodiments 19-32 insofar as dependent on embodiment 18, comprising an electric propulsion motor connected to the hub shell, the electric propulsion motor being arranged within the sealed hub chamber.

Embodiment 34. Hub assembly of embodiment 33, wherein the electric propulsion motor is connected to the hub shell via the transmission.

Embodiment 35. Hub assembly of embodiment 33, comprising a reduction gear between the electric motor and the transmission input.

Embodiment 36. Hub assembly of any of embodiments 1-35, wherein the sprocket is part of a cassette or set of sprockets including at most ten different sprockets, particularly at most eight different sprockets, more particular at most six different sprockets, more particular at most four different sprockets.

Embodiment 37. Hub assembly of any of embodiments 1-36, wherein the sprocket is movable in axial direction relative to the driver, and wherein the hub assembly comprises an actuator for actuating the sprocket in the axial direction.

Embodiment 38. Hub assembly of any of embodiments 1-37, comprising a battery and a wired connection between the battery and an actuator of the transmission, particularly of the continuously variable transmission.

Embodiment 39. Hub assembly of any of embodiments 1-38, comprising an antenna for wirelessly communicating with an external component, such as a controller and/or a shifter, wherein the antenna is optionally arranged within the sealed hub chamber.

Embodiment 40. Hub assembly of embodiment 39 insofar as dependent on embodiment 8 or 9, wherein the antenna is associated with, e.g. coupled to, the first axle part.

Embodiment 41. Hub assembly of any of embodiments 1-40, comprising a generator for generating electric power, the generator being particularly operatively arranged between an axle or axle part and a component of the assembly rotatable relative to the axle or axle part.

Embodiment 42. Hub assembly of embodiment 41, wherein the generator is arranged within the sealed hub chamber.

Embodiment 43. Hub assembly of any of embodiments 1-42, comprising a controller for controlling the transmission.

Embodiment 44. Hub assembly of embodiment 43, comprising a wired connection between the controller and the transmission.

Embodiment 45. Hub assembly of embodiment 44, insofar as dependent on at least embodiment 2 and embodiment 20, wherein the controller is arranged for controlling the continuously variable transmission as well as the planetary transmission.

Embodiment 46. Hub assembly of embodiment 45, wherein the controller is arranged for further controlling a derailleur.

Embodiment 47. Hub assembly of any of embodiments 1-46, comprising an axle extending longitudinally along the second axis between a drive side end near the driver and a non-drive side end opposite the drive side; and a torque support for supporting torque from the axle onto a frame of the bicycle, wherein the torque support is optionally arranged at the drive side.

Embodiment 48. Hub assembly of embodiment 47, wherein the torque support is configured for engaging a derailleur mount of the bicycle frame.

Embodiment 49. Hub assembly of embodiment 48, wherein the torque support integrated with the derailleur mount.

Embodiment 50. Driver assembly for a bicycle wheel, comprising:
a first drive element connected to a sprocket and rotatable about a first axis;
a second drive element connectable to a hub shell and rotatable about a second axis, the first drive element being movable relative to the second drive element in a direction transverse to the first and second axis;
coupling elements provided at a constant first radius from the first axis and at a variable second radius from the second axis, or at a constant first radius from the second axis and at a variable second radius from the first axis, for transferring torque between the first drive element and the second drive element.

Embodiment 51. Driver assembly of embodiment 50, wherein the coupling elements are coupled to the second drive element in a tangential direction, and movable relative to the second drive element in a radial direction,
wherein the coupling elements are coupled to the first drive element in a radial direction at the first radius from the first axis, and movable relative to the first drive element in a first tangential direction, and wherein the coupling elements are couplable to the first drive element in a second tangential direction opposite the first tangential direction.

Embodiment 52. Wheel for a bicycle, comprising a hub assembly according to any of embodiments 1-49 and/or a driver assembly of embodiment 50 or 51.

Embodiment 53. Bicycle, comprising a wheel according to embodiment 52, and/or a hub assembly according to any of embodiments 1-49 and/or a driver assembly of embodiment 50 or 51.

Embodiment 54. Drive train for a bicycle, comprising a hub assembly according to any of embodiments 1-49 or a driver assembly of embodiment 50 or 51, and further comprising a crank assembly comprising a crank, a sprocket and a crank transmission arranged between the crank and the sprocket, selectively operable according to a plurality of different transmission ratios.

Embodiment 55. Drive train of embodiment 54, wherein the crank assembly comprises an electric propulsion motor.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A hub assembly for a bicycle wheel, comprising
a driver, rotatable about a first axis, for being mounted to a sprocket;
a hub shell, rotatable about a second axis parallel to the first axis, for being mounted to the bicycle wheel;
a transmission selectively operable according to a plurality of different transmission ratios, and operatively connected between the driver and the hub shell; and
an electric propulsion motor connected to the hub shell via the transmission.

2. The hub assembly of claim 1, wherein the transmission comprises a transmission input and a transmission output, wherein the driver is connected to the transmission input for driving the transmission, wherein the electric propulsion motor is connected to the transmission input for driving the transmission, and wherein the transmission output is connected to the hub shell for driving the hub shell according to one of the plurality of different transmission ratios.

3. The hub assembly of claim 1, comprising a sealed, hub chamber formed by the hub shell, the hub chamber housing the transmission and the electric propulsion motor.

4. The hub assembly of claim 1, wherein the hub shell comprises an inner part housing the transmission and the electric propulsion motor, and an outer part for being mounted to the bicycle wheel, wherein the outer part is removably mounted to the inner part.

5. The hub assembly of claim 2, comprising a reduction gear between the electric propulsion motor and the transmission input.

6. The hub assembly of claim 2, comprising a freewheel between the driver and the transmission input.

7. The hub assembly of claim 2, comprising a freewheel between the electric propulsion motor and the transmission input.

8. The hub assembly of claim 1, wherein the electric propulsion motor has a stator that is rotationally coupled to a wheel axle of the hub assembly, and a rotor that is rotatably arranged relative to the stator.

9. The hub assembly of claim 1, wherein the electric propulsion motor is concentric about the second axis.

10. The hub assembly of claim 1, comprising a thru-axle extending through a hollow wheel axle of the hub assembly.

11. The hub assembly of claim 3, wherein the transmission comprises a planetary transmission selectively operable according to the plurality of different transmission ratios.

12. The hub assembly of claim 11, comprising an intermediate drive part having an input connected to the driver and an output connected to the planetary transmission, wherein the intermediate drive part extends between the intermediate drive part output internal to the hub chamber and the intermediate drive part input external to the hub chamber.

13. The hub assembly of claim 11, wherein the planetary transmission includes a first planetary gear set selectively operable according to a first transmission ratio and a second transmission ratio and having a first clutch for switching from the first transmission ratio to the second transmission ratio and/or vice versa.

14. The hub assembly of claim 1, wherein the sprocket is part of a cassette or set of sprockets including at most ten different sprockets.

15. The hub assembly of claim 3, comprising an antenna for wirelessly communicating with an external component, a controller, and/or a shifter, wherein the antenna is arranged within the sealed hub chamber.

16. The hub assembly of claim 1, comprising a controller for controlling the transmission, wherein the controller is arranged for further controlling a derailleur.

17. The hub assembly of claim 1, comprising an axle extending longitudinally along the second axis between a drive side end near the driver and a non-drive side end opposite the drive side end; and a torque support for supporting torque from the axle onto a frame of a bicycle, wherein the torque support is arranged at the drive side end.

18. A wheel for a bicycle, comprising the hub assembly according to claim 1.

19. A bicycle comprising the wheel according to claim 18.

20. A drive train for a bicycle, comprising the hub assembly according to claim 1 and further comprising a crank assembly comprising a crank, a chain ring and a crank transmission arranged between the crank and the chain ring, selectively operable according to a plurality of different transmission ratios.
